(19) United States
(12) Patent Application Publication
(10) Pub. No.: US 2007/0288605 A1
(43) Pub. Date: Dec. 13, 2007

(54) Method and system for bulk negation of network configuration-commands

(75) Inventors: Mahesh Kumar Doraiswamy, Coimbatore (IN); Anbalagan Vivekanandam, Thanjavur (IN)

Correspondence Address: CRAIG E. SHINNERS;LAW OFFICE OF CRAIG E. SHINNERS, 301 E. COLORADO BLVD, SUITE 610, PASADENA, CA, 91101, US

(73) Assignee: Cisco Technology, Inc., San Jose, CA (US)

(21) Appl. No.: 11/448,528

(22) Filed: Jun. 7, 2006

(51) Int. Cl. G06F 15/177

(52) U.S. Cl. 709/220

(57) ABSTRACT

In one embodiment, a method and a system for negation of multiple configuration-commands at the Command Line Interface (CLI) have been provided. The invention provides a ‘no-wrapper’ sub-mode command for the CLI. The ‘no-wrapper’ sub-mode command negates the multiple configuration-commands from a configuration of the network device. The negation of the multiple configuration-commands is implemented through a parser, which runs on the OS of a network device.

### BACKGROUND OF THE INVENTION

1. Field of Invention

Embodiments of the invention relate in general to modifying the configuration of a network device. More specifically, the embodiments of the invention relate to a method and a system for bulk negation of network configuration-commands at the Command Line Interface (CLI) of the network device.

2. Description of the Background Art

Configuration files are used to define the operating characteristics for network devices such as routers or switches. Configuration files are often written in ASCII and are line-oriented. The general format of a configuration is quite simple. Each statement includes a keyword and one or more arguments. Each line comprises a statement or configuration-command that, by way of example, enables or disables various interfaces, adds or removes IP addresses or sets passwords.

Often times situations may arise where it is necessary to remove a portion of the configurations from the network device. For example, the portion may be a set of host commands in a host database or a set of access list statements in an access list.

Typically a terminal-type means for sending commands to the shell and entering data into the network device is provided to view or modify the configurations. One such terminal-type means for editing the configurations is know as the Command Line Interface (CLI). The CLI is indicated by a symbol, or prompt showing the user where to enter commands. Unlike a graphical user interface, this interface requires that commands be typed in and written in a precise syntax in order for them to be interpreted correctly by the shell.

Removal of a bulk portion of the configurations can be a tedious process since each configuration-command must be individually removed. To remove a configuration-command, the keyword and arguments from each line must be precisely entered into the CLI preceded by a “no” command or some other command that indicates that the line has to be removed or negated. This repetitious process for negating multiple configuration-commands is time consuming and prone to human error.

### BRIEF DESCRIPTION OF THE DRAWINGS

FIG. 1 illustrates an environment in accordance with an embodiment of the present invention.

FIG. 2 is a block diagram of a network device in accordance with an exemplary embodiment of the invention.

FIG. 3 is a block diagram of interfaces, in accordance with an exemplary embodiment of the invention.

FIG. 4 is a block diagram of an interface, in accordance with an exemplary embodiment of the invention.

FIG. 5 shows a flowchart illustrating a method for negating multiple configuration-commands in accordance with an exemplary embodiment of the invention.

### DETAILED DESCRIPTION OF EMBODIMENTS OF THE INVENTION

Embodiments of the invention provide methods and systems for negation of network configuration-commands. In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are specifically not shown or described in detail to avoid obscuring aspects of embodiments of the present invention.

Configurations are used to configure the initial settings for a network device. The configurations are used by the Operating System (OS) of the network device. Examples of configurations include, but are not limited to, configuration-commands for enabling or disabling various interfaces; addition or removal of IP addresses, hosts; setting passwords; addition or removal of access list statements, etc. The various configuration-commands may be contiguous or non-contiguous. In accordance with various embodiments of the invention, configuration-commands are part of a running-configuration of the network device. Running-configuration represents the configuration of the network device at any given instant.

A user can view or modify the configuration by sending commands to the shell of the network device through an interface. The interface can be implemented in the form of a visual display with a command prompt. An embodiment of the invention provides a ‘no wrapper’ sub-mode command whereby, negation of a multiple set of configuration-commands from the configuration can be implemented through a minimum number of operations. The interface has different command modes and sub-modes, providing different access privileges and functionalities to its users. The interface enters into the ‘no wrapper’ command sub-mode when the ‘no wrapper’ sub-mode command is entered on the interface. In the ‘no wrapper’ sub-mode of the interface, the multiple configuration-commands can be negated in one step from the configuration of the network device. The user can view the configuration and hence the multiple-configuration commands on the interface of the network device. The user identifies the multiple configuration-commands from the configuration and then activates the ‘no wrapper’ sub-mode by entering the ‘no wrapper’ sub-mode command on the interface. The identification of multiple configuration-commands can be done through various means including, copying the configuration-commands from the interface, highlighting the configuration-commands, selecting the configuration-commands, etc. Thereafter, the user associates the identified multiple configuration-commands with the ‘no wrapper’ sub-mode command. The association of the identified configuration-commands can be done through various means including, providing the identified configuration command on the interface, pasting the identified configuration-command on the ‘no wrapper’ sub-mode command prompt, highlighting the ‘no wrapper’ sub-mode command prompt, selecting the ‘no wrapper’ sub-mode command prompt, etc. The interface is linked with a parser for analyzing the commands that are entered into the command prompt of the interface under various modes and sub-modes. In the ‘no wrapper’ sub-mode, the parser automatically pre-fixes a ‘no’ prefix to each of the subsequent multiple configuration-commands that are entered on the interface for negation. Whereupon, the pre-fixed ‘no’ command negates the identified multiple configuration-commands from the configuration of the network device. Therefore, the use of the ‘no wrapper’ sub-mode command allows the negation of multiple sets of configuration-commands with minimal operations on the interface.

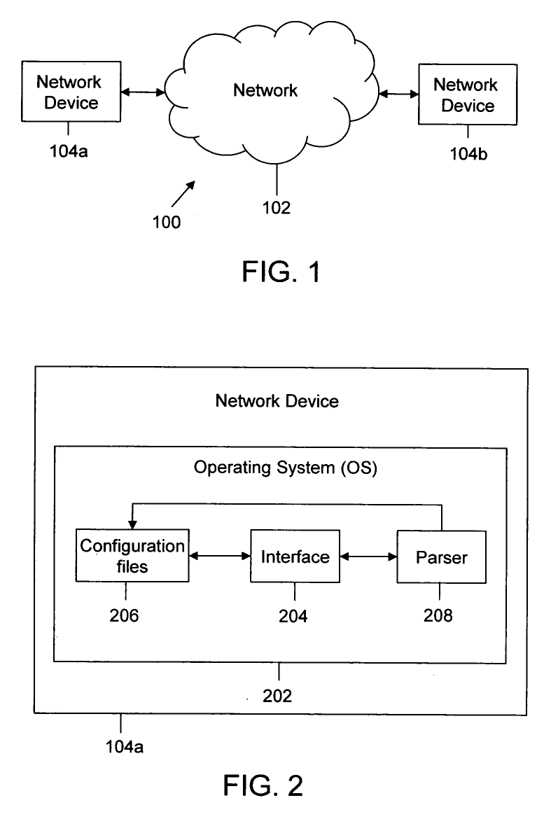

Referring now to the drawings, particularly by their reference numbers, FIG. 1 illustrates environment 100 in accordance with an embodiment of the present invention. Environment 100 includes network 102 and network devices 104 that include network device 104a and network device 104b. Network devices 104 are connected to each other through network 102. Examples of network 102 include, but are not limited to, a Wide Area Network (WAN) or a Local Area Network (LAN), a client-server network, a peer-to-peer network, and so forth. Examples of network devices 104 include, but are not limited to a router, a switch, or other network infrastructure device.

FIG. 2 is a block diagram of network device 104a, in accordance with an exemplary embodiment of the invention. Network device 104a includes Operating System (OS) 202. OS 202 is a multitasking operating system, which runs on network device 104a. OS 202 provides kernel services such as process scheduling, interfacing and a variety of software for routing and switching. Kernel is a program that provides secure access to the hardware and various executable processes of network device 104a. Examples of OS 202 include, but are not limited, to Internetworking Operating System (IOS).

OS 202 includes interface 204, configurations 206 and parser 208. Interface 204 is a visual interface, including a command prompt, for communicating input commands or instructions to OS 202. In accordance with various embodiments of the invention, the input instructions are communicated by a user in the form of commands, which are recognized by OS 202. For example, the commands are stored in a registry of OS 202 for recognition by parser 208. Interface 204 receives the commands through an external device, which allows the user to communicate these commands with network device 104a. Examples of external device include but are not limited to, a keyboard, a mouse and other such devices. The external devices facilitate the communication between the user and interface 204 for communicating commands related to the configuration of the network device, routing or switching decisions, among others. The user can configure network device 104a by communicating configuration-commands through interface 204.

The user can also monitor and manage the status and configuration of network device 104a through interface 204. In accordance with various embodiments of the invention, on the basis of user privileges, interface 204 provides different levels of access-rights to its users. These user privileges can be implemented by means of a network-administrator password or other such secure means. Interface 204 is the Command Line Interface (CLI).

Interface 204 has different command modes and sub-modes, providing different access privileges to its users. For example, Internetworking Operating System (IOS) supports the communication between the user and network device 104a through interface 204. Interface 204 has different command modes such as user mode, privileged mode, and configuration mode. The user mode is the first mode that a user accesses upon activating network device 104a. The user mode allows the user to execute only the basic commands, such as a command to show the status of the system. The user mode does not allow the user to change the status of network device 104a or to restart it. The user can enable network device 104a to switch from the user mode to the privileged mode by executing a password or other such secure mechanisms. The privileged mode allows the user to view system configuration, to restart network device 104a, and to enter the configuration mode. The privilege mode also allows the user to view all the commands available in the user mode. The configuration mode allows the user to add and modify a running-configuration. Based on the particular sub-mode entered by the user, the command prompt of the CLI accordingly varies, to represent the entered sub-mode.

Configuration files 206 represent the configuration that is executed at any instant on network device 104a. Configuration files 206 are stored in a database of network device 104a at the time of configuration of network device 104a. Configuration files 206 include a number of configuration-commands. Configuration files 206 are viewed by the user on interface 204 by executing a command such as ‘show config’ on interface 204. Configuration-files 206 may include multiple configuration-commands, which the user has identified for negation. The multiple configuration-commands may be contiguous or non-contiguous. Examples of multiple configuration-commands include a set of host commands, and access list statements.

Parser 208 is a software program that analyzes the grammatical structure of the commands that are communicated by the user through interface 204. In accordance with an embodiment of the invention, the user executes the ‘no wrapper’ sub-mode command for negating multiple configuration-commands with a minimum number of operations. Parser 208 analyzes and implements the ‘no wrapper’ sub-mode command when the command is executed by the user through interface 204. During the implementation of the ‘no wrapper’ sub-mode command, a ‘no’ syntax is pre-fixed within the command prompt of interface 204. The user identifies the multiple configuration-commands, and associates the entire set of multiple configuration-commands in one step with the ‘no wrapper’ sub-mode command on the command prompt of interface 204. For example, the user copies the multiple configuration-commands, and provides the copied multiple configuration-commands on the command prompt of interface 204. In another embodiment, the user highlights the configuration-commands to be negated and the ‘no wrapper’ sub-mode command prompt to form the association. In yet another embodiment, the user selects the configuration-commands to be negated and the ‘no wrapper’ sub-mode command prompt to form the association, etc. Thereafter, the multiple configuration-commands are negated from the configuration of network device 104a as a bulk operation.

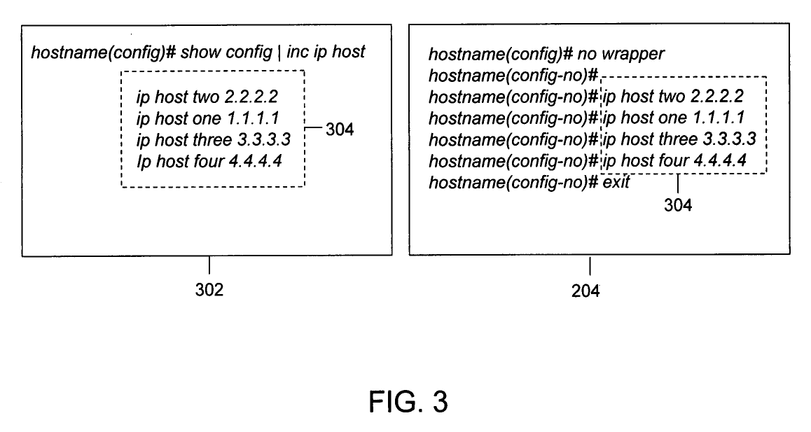

FIG. 3 is a block diagram of interface 204 and interface 302, in accordance with an exemplary embodiment of the invention. Interface 302 shows multiple configuration-commands 304 relating to some ‘IP hosts’ which the user has identified for negation from the configuration of network device 104a. The user enters a ‘show running-config|inc ip host’ command on the command prompt of interface 302 to view multiple configuration-commands 304. Whereupon, multiple configuration-commands 304 appear on interface 302 as follows:
ip host two 2.2.2.2
ip host one 1.1.1.1
ip host three 3.3.3.3
ip host four 4.4.4.4 (1)
   Interface 204 shows the implementation of the ‘no wrapper’ sub-mode command. The user first copies multiple configuration-commands 304 from interface 302 and then enters the ‘no wrapper’ command on the command prompt of interface 204, thereby entering the ‘no wrapper’ sub-mode. The user then pastes the copied multiple configuration-commands 304 on to the command prompt of interface 204. These steps appear on interface 204 as stated below:
hostname(config)#no wrapper
hostname(config-no)#ip host two 2.2.2.2
hostname(config-no)#ip host one 1.1.1.1
hostname(config-no)#ip host three 3.3.3.3
hostname(config-no)#ip host four 4.4.4.4
hostname(config-no)#exit
   Wherein, ‘hostname (config-no) #’ is the command prompt of interface 204; ‘hostname’ is the name of network device 104a; ‘no’ represents the ‘no wrapper’ sub-mode; and ‘config’ represents the user-access privileges for modifying the configuration of network device 104a; ‘exit’ is a command for exiting the ‘no-wrapper’ sub mode.

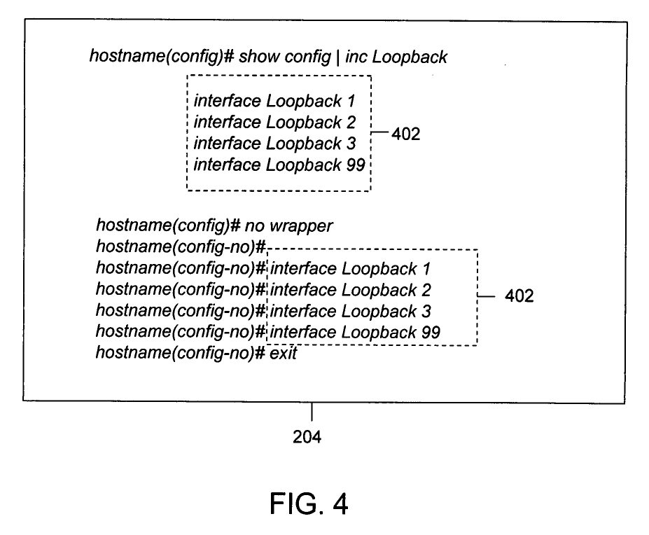

FIG. 4 is a block diagram of interface 204, in accordance with an exemplary embodiment of the invention. The user identifies multiple configuration-commands 402 relating to ‘loopback interfaces’ for negation from the configuration of network device 104a. The user will first enter a ‘show running-config|inc Loopback’ command on the command prompt of interface 204 to view multiple configuration-commands 402. Multiple configuration-commands 402 appear on interface 204 as follows:
interface Loopback1
interface Loopback2
interface Loopback3
interface Loopback99 (2)
   The user then copies multiple configuration-commands 402. The user now enters the ‘no wrapper’ command on the command prompt of interface 204, thereby entering the ‘no wrapper’ sub-mode. The user then pastes the copied multiple configuration-commands 402 on to the command prompt of interface 204. These steps appear on interface 204 as below:
hostname(config)#no wrapper
hostname(config-no)#interface Loopback1
hostname(config-no)#interface Loopback2
hostname(config-no)#interface Loopback3
hostname(config-no)#interface Loopback99
hostname(config-no)#exit

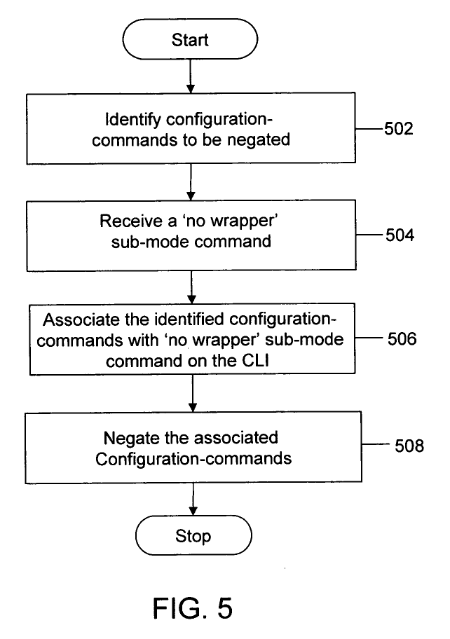

FIG. 5 shows a flowchart illustrating a method for negating multiple configuration-commands, in accordance with an exemplary embodiment of the invention. At 502, the user identifies configuration-commands for negation. The configuration-commands are identified by the user for negation from the configuration of network device 104a. At 504, interface 204 of network device 104a receives a ‘no wrapper’ sub-mode command from the user. Parser 208 parses the ‘no wrapper’ sub-mode command whereupon the ‘no’ command is pre-fixed to the subsequent commands that are entered on the command prompt of interface 204. At 506, the user associates the plurality of configuration-commands with the no wrapper’ sub-mode command on the command prompt of interface 204. At 508, the associated configuration-commands are negated from the configuration of network device 104a. The invention is not limited to only one set of multiple configuration-commands, as it is also applicable to contiguous as well as non-contiguous multiple configuration-commands.

According to an embodiment of the present invention, a method for negating configuration-commands for a network device is provided. The method comprises: identifying a plurality of the configuration-commands to be negated; receiving a command for negating the identified configuration-commands; associating the identified configuration-commands with the command for negating; and negating the associated configuration-commands.

In another embodiment of the present invention, computer instructions for negating configuration-commands for a network device have been provided. The computer instructions are encoded in computer-readable media and are executable by a processor. The computer instructions comprise: logic for identifying a plurality of the configuration-commands to be negated; logic for receiving a command for negating the identified configuration-commands; logic for associating the identified configuration-commands with the command for negating; and logic for negating the associated configuration-commands.

In other embodiments of the present invention, a computer logic in a processing system including a processor coupled to a display and user input device, for negating configuration-commands in a network device has been provided. The computer logic comprises: one or more instructions for identifying a plurality of the configuration-commands to be negated; one or more instructions for receiving a command for negating the identified configuration-commands; one or more instructions for associating the identified configuration-commands with the command for negating; and one or more instructions for negating the associated configuration-commands.

In another embodiment of the present invention, an apparatus for negating configuration-commands for a network device has been provided. The apparatus comprising: means for identifying a plurality of the configuration-commands to be negated; means for associating the identified configuration-commands with a negating command; and means for negating the associated configuration-commands.

Embodiments of the present invention provide a method and a system for negating a configuration at an interface of a network device. In an embodiment of the invention, a ‘no wrapper’ sub-mode command allows a user to easily negate multiple configuration-commands with minimum number of operations. Embodiments of the present invention provide a mechanism for the removal of configuration-commands from the configuration of the network device. For example, the configuration-commands can be identified for negation from the configuration of the network device and can then be copied from the configuration. The copied configuration-commands are associated with the ‘no-wrapper’ sub-mode on the interface and are subsequently negated by a parser in only one step. Therefore, the number of operations is significantly reduced. This results in improved productivity during the negation of the multiple commands.

Although the invention has been discussed with respect to specific embodiments thereof, these embodiments are merely illustrative, and not restrictive, of the invention. For example, a ‘Method and System for Bulk Negation of Network Configuration-Commands’ can include any type of analysis, manual or automatic, to anticipate the needs of bulk negation.

Although specific protocols have been used to describe embodiments, other embodiments can use other transmission protocols or standards. Use of the terms ‘peer’, ‘client’, and ‘server’ can include any type of device, operation, or other process. The present invention can operate between any two processes or entities including users, devices, functional systems, or combinations of hardware and software. Peer-to-peer networks and any other networks or systems where the roles of client and server are switched, change dynamically, or are not even present, are within the scope of the invention.

Any suitable programming language can be used to implement the routines of the present invention including C, C++, Java, assembly language, etc. Different programming techniques such as procedural or object oriented can be employed. The routines can execute on a single processing device or multiple processors. Although the steps, operations, or computations may be presented in a specific order, this order may be changed in different embodiments. In some embodiments, multiple steps shown sequentially in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Although specific types of software such as a “file manager” may be discussed as performing certain functions, other embodiments may perform such functions in other software or devices or a combination of both, as desired.

Also in the description herein for embodiments of the present invention, a portion of the disclosure recited in the specification may contain material, which is subject to copyright protection. Computer program source code, object code, instructions, text or other functional information that is executable by a machine may be included in an appendix, tables, figures or in other forms. The copyright owner has no objection to the facsimile reproduction of the specification as filed in the Patent and Trademark Office. Otherwise all copyright rights are reserved.

A ‘computer’ for purposes of embodiments of the present invention may include any processor-containing device, such as a mainframe computer, personal computer, laptop, notebook, microcomputer, server, personal data manager or ‘PIM’ (also referred to as a personal information manager), smart cellular or other phone, so-called smart card, set-top box, or any of the like. A ‘computer program’ may include any suitable locally or remotely executable program or sequence of coded instructions, which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images. If a computer is employed for presenting media via a suitable directly or indirectly coupled input/output (I/O) device, the computer would have suitable instructions for allowing a user to input or output (e.g., present) program code and/or data information respectively in accordance with the embodiments of the present invention.

A ‘computer readable medium’ for purposes of embodiments of the present invention may be any medium that can contain, store, communicate, propagate, or transport the computer program for use by or in connection with the instruction execution system apparatus, system or device. The computer readable medium can be, by way of example only but not by limitation, an electronic, magnetic, optical, electromagnetic, infrared, or semiconductor system, apparatus, system, device, propagation medium, or computer memory.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general-purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for negating configuration-commands for a network device, the method comprising:
identifying a plurality of the configuration-commands to be negated;
receiving a command for negating the identified configuration-commands;
associating the identified configuration-commands with the command for negating; and
negating the associated configuration-commands.

2. The method of claim 1, wherein identifying the plurality of the configuration commands comprises:
copying the configuration-commands.

3. The method of claim 1, wherein identifying the plurality of the configuration-commands comprises:
highlighting the configuration-commands.

4. The method of claim 1, wherein identifying the plurality of the configuration-commands comprises:
selecting the configuration-commands.

5. The method of claim 1, wherein the command for negating is a no-wrapper sub-mode command.

6. The method of claim 1, wherein associating the identified configuration-commands with the command for negating comprises:
providing the identified configuration-commands on an interface.

7. The method of claim 1, wherein the identifying the plurality of the configuration-commands, receiving the command for negating, and associating the identified configuration-commands with the command for negating, occur at an interface.

8. The method of claim 1, associating the identified configuration-commands with the command for negating further comprises:
prefixing a ‘no’ to each of the associated plurality of configuration-commands.

9. The method of claim 1, wherein the identifying the plurality of configuration-commands to be negated comprises:
identifying at least one configuration-command.

10. The method of claim 1, wherein the identified configuration-commands are contiguous in a configuration of the network device.

11. The method of claim 1, wherein the identified configuration-commands are non-contiguous in a configuration of the network device.

12. The method of claim 1 further comprises providing a Command Line Interface (CLI) for identifying and receiving.

13. The method of claim 1, wherein the network device is a router.

14. The method of claim 1, wherein the network device is a switch.

15. Computer instructions for negating configuration-commands for a network device, the computer instructions encoded in computer-readable media and executable by a processor, the computer instructions comprising:
logic for identifying a plurality of the configuration-commands to be negated;
logic for receiving a command for negating the identified configuration-commands;
logic for associating the identified configuration-commands with the command for negating; and
logic for negating the associated configuration-commands.

16. The computer instructions according to claim 15, further comprising:
logic for copying the configuration-commands.

17. The computer instructions according to claim 15, further comprising:
logic for highlighting the configuration-commands.

18. The computer instructions according to claim 15, further comprising:
logic for selecting the configuration-commands.

19. The computer instructions according to claim 15, further comprising:
logic for providing the identified configuration-commands on an interface.

20. The computer instructions according to claim 15, further comprising:
logic for prefixing a ‘no’ to each of the associated plurality of configuration-commands.

21. The computer instructions according to claim 15, further comprising:
logic for identifying at least one configuration-command.

22. In a processing system including a processor coupled to a display and user input device, computer logic for negating configuration-commands in a network device comprising:
one or more instructions for identifying a plurality of the configuration-commands to be negated;
one or more instructions for receiving a command for negating the identified configuration-commands;
one or more instructions for associating the identified configuration-commands with the command for negating; and
one or more instructions for negating the associated configuration-commands.

23. The computer logic according to claim 22, wherein one or more instructions for associating the identified configuration-commands with the command for negating are implemented by a parser.

24. An apparatus for negating configuration-commands for a network device, the apparatus comprising:
means for identifying a plurality of the configuration-commands to be negated;
means for associating the identified configuration-commands with a negating command; and
means for negating the associated configuration-commands.
